(19) United States
(12) Patent Application Publication
(10) Pub. No.: US 2024/0066765 A1
(43) Pub. Date: Feb. 29, 2024

(54) FIBER MATERIAL FOR PRODUCING A CONTAINER, METHOD FOR PRODUCING A CONTAINER USING THE FIBER MATERIAL, AND CONTAINER COMPRISING THE FIBER MATERIAL

(71) Applicant: Krones AG, Neutraubling (DE)

(72) Inventors: Jörg ZACHARIAS, Koefering (DE); Thomas ALBRECHT, Beilngries (DE); Matthias WAHL, Langquaid (DE); Frank WINZINGER, Regensburg (DE); Patrick ENGELHARD, Elsendorf (DE); Michael NEUBAUER, Grassau (DE); Angelika GROSSER, Emmerting (DE)

(21) Appl. No.: 18/450,323

(22) Filed: Aug. 15, 2023

(30) Foreign Application Priority Data
Aug. 25, 2022 (DE) 10 2022 121 490.7

(51) Int. Cl. B29C 43/00; B29C 49/00; B29C 49/42

(52) U.S. Cl. CPC B29C 43/006; B29C 43/003; B29C 49/0005; B29C 49/42822; B29L 2031/712

(57) ABSTRACT

The disclosure relates to a fiber material for producing a container, wherein the fiber material comprises fiber structures for ensuring a predetermined stability of a container produced from the fiber material. Furthermore, the disclosure relates to a method for producing a container using the fiber material, and container comprising the fiber material.

### CROSS REFERENCE TO RELATED APPLICATION

The present application claims priority to German Patent Application No. 10 2022 121 490.7 filed on Aug. 25, 2022. The entire contents of the above-listed application are hereby incorporated by reference for all purposes.

### TECHNICAL FIELD

The disclosure relates to a fiber material for producing a container, a method for producing a container, and a container comprising the fiber material.

### BACKGROUND

For the production of bottles comprising fibers, such as, for example, pulp bottles, the starting material is a fluid mass which comprises water and fibers, such as wood and/or cellulose fibers. The fibers are generally not characterized by any particular structure or shape. Although flat bodies and bottles can thus be made from the fluid mass, they do not have any particular rigidity due to the fibrous structure of the fibers in the fluid mass. It may therefore be the case that, bottles may lack the necessary robustness with respect to, for example, bursting, top-loading during stacking or normal handling by an end user.

### SUMMARY

### Object

The object of the disclosure is to provide a fiber material for producing a container, a method for producing a container, and a container comprising the fiber material which allow a container to be made that has sufficient strength and stability.

### Achievement

The problem is solved by the fiber material for producing a container, the method for producing a container, and the container comprising the fiber material as described herein.

The fiber material according to the disclosure for producing a container, wherein the fiber material comprises fiber structures for ensuring a predetermined stability of a container produced from the fiber material.

Due to the fiber structures, necessary properties for a container to be produced can be achieved.

The fiber structures can comprise viscose fibers. A viscose fiber is an artificial fiber made of regenerated cellulose, wherein the viscose fibers have, as starting base, 100% cellulose treated in a multi-stage process.

The fiber structure can comprise a trilobal shape or a double trilobal shape. A trilobal shape comprises a Y-shaped cross-section, and a double trilobal shape comprises a double Y-shaped cross-section. Due to the trilobal or double-trilobal structure, the fibers can be resistant to bending.

The fiber structures can comprise a planar structure. The tear strength can be increased by overlapping a plurality of such fiber structures.

The fiber structures can comprise a hollow structure. The hollow structure can allow the fiber structures to be lightweight while still having a stiffening effect.

The fiber structures can comprise a corrugated or rough outer surface. The corrugated or rough surface can cause the fiber structures to interlock and increase tear strength and stability.

The fiber structures can comprise a predetermined fiber length distribution of fibers.

The fibers of the fiber structures can comprise lignin, banana leaves, quinine, glass fibers, metal threads and/or sutures. The fibers can comprise, for example, fibers from coniferous woods, leafy woods, and/or sycamores, and/or from grasses, reeds, and/or bamboo, or the like. Lignin can have a supportive effect on the cellulose and may also be suitable for transparent applications. Banana leaves can be suitable for larger containers, such as single use tableware. An improvement in the strength can be achieved by embedding glass fibers, metal threads and/or sutures.

The fibers can comprise silk threads, coil threads, algae, natural fibers (such as Donau silphie fibers, hemp, corn, cotton, straw, burning nettle, wheat, sisal, kenaf, abaca), banana peels, orange peels, grass, straw, potato starch or processed cow manure. Also, cellulose fibers can be provided which originate from a process by which they were artificially grown. These alternative materials can completely or partially replace wood as the base material for a fluid mass with fibers when there are material shortages.

The fibers may or may comprise virgin fibers or recycled fibers. It may be provided that only virgin fibers, that only recycled fibers, or that a blend of virgin fibers and recycled fibers may be used.

Due to the natural origin of the fibers, they can be biodegradable. They are also sustainable and renewable and/or can be recycled and reused.

The fiber structures may comprise a fabric structure or a mixture of different fabrics and/or celluloses and/or wood fibers.

The fiber structures may be processed to form a fleece structure that can then be used. Instead of the fleece structure, it is also possible to create and use an interwoven, knitted or crocheted flat fabric from the fiber structures. The fleece structure or the flat fabric can be introduced into a mold for producing the container and then mixed with a fluid mass which comprises fibers and/or fiber structures.

The fiber structures can comprise fiber mixtures made of non-wood material, for example cotton, and/or textile fibers which comprise, for example, barrier properties, and/or crepe paper tube and/or knitted tube and/or cotton net and/or hemp.

The previously mentioned fiber structures can also be used in combination in the fiber material. For example, fiber structures with different outer surfaces, and/or shapes, and/or a hollow structure, and/or a flat structure, and/or of different materials can be combined. Two, three, four or more different fiber structures can be combined in the fiber material.

For the production of a fiber-containing fluid mass which can be required for example for a method for producing a container, a type of fiber structures or two or more different types of fiber structures can be introduced into a fluid, for example water.

The fiber material can be usable for a preform of a container to be produced therefrom. Such a preform can be introduced into a container stretch blow molding machine for a process to produce the container. The stretch blow molding machine can bring the preform into a predetermined container shape by supplying hot air, wherein the hot air can have a temperature of 60° C. to 250° C., for example, and/or steam, wherein the steam can have a temperature of 100° C. to 300° C., for example. The preform can be designed in such a way that a uniformly wall thickness can be obtained during a process to produce the container in the stretch blow molding machine. The range limits may always be included.

The fiber material which can be used for a preform of a container to be produced therefrom can comprise fiber structures of natural origin. For example, one type or several different types of fiber structures can be provided. The fiber structures can be or comprise primary and/or secondary fibers, for example birch, pine, grass and/or hemp. In addition, the fiber material can comprise inorganic fillers, for example chalk and/or Kaolin, and/or organic fillers, such as, for example, microfibrillated cellulose (MFC), psyllium husks, starch and/or modified starch. In addition or alternatively, the fiber material can comprise biobased binders such as for example cellulose ethers, carboxymethyl cellulose, starch ethers, xanthan, guar, pectins, agar, gelatin and/or gum arabic. In addition or alternatively, the fiber material can comprise biobased additives such as for example sunflower lecithin. In addition or alternatively, the fiber material can comprise colorants. The colorants may be biobased.

The fiber material may comprise 0% to 100% long fiber cellulose, 0% to 100% short fiber cellulose, 0% to 100% recycled paper fibers, 0% to 100% annual plant cellulose, and/or 0% to 100% cotton fibers. The respective upper range limits of 100% may be included. For example, the fibers of long fiber cellulose can have a length of more than 1 cm. For example, the fibers of the short fiber cellulose can have a length of 1 mm to 8 mm. For the production of a fiber-containing fluid mass which can be used, for example, for a method for producing a preform of the container to be produced therefrom, a mixture of the fiber material with a fluid, for example water, can be produced in a mass ratio of 99:1 to 1:99 can be provided. The range limits may be included.

A method for producing a container using the fiber material as described above or below is provided.

The method comprises introducing the fiber material into a mold, pressing the fiber material in the mold and producing the container.

The fiber material can be in the form of a fiber-containing fluid mass for introduction into the mold. The fiber-containing fluid mass can be or comprise pulp. The fluid portion of the mass can comprise water.

Alternatively, the method may comprise introducing a first layer of the fiber material into a mold for forming an outer surface of the container, introducing a second layer of the fiber material which is sterile into the mold on the first layer to form an inner surface of the container, pressing the first and second layer in the mold, and manufacturing the container.

The fiber material for the second layer can already be provided sterile for the method, for example by providing silver ions, or the fiber material for the second layer can be sterilized before the introduction.

For the second layer, instead of the sterile fiber material, a fiber material used for the first time, which may for example be non-sterile, or which may for example be sterile or sterilized prior to insertion, and a recycled fiber material may be used instead of the first layer.

It can also be provided that after introduction of a first layer of the fiber material into a mold for forming an outer surface of the container, a fibrous structure in the form of a mesh, for example a cotton material, is arranged on the first layer, and a second layer of the fiber material is then applied to the mesh in order to form an inner surface of the container.

A sterile fiber material or a fiber material used for first time can be used for the second layer, and a recycled or non-sterile fiber material can be used for the first layer. The same fiber material can also be used for the first and the second layer.

The method can further comprise a sterilization of the fiber material for the second layer before introduction.

Alternatively, a method for producing a container using the fiber material, as described above or below, can comprise producing a preform from the fiber material, introducing the preform into a stretch blow molding machine, and shaping the container in the stretch blow molding machine. For the fiber material, the fiber material can be provided which was mentioned above or below in connection with a preform of a container to be produced therefrom.

The shaping of the container in the stretch blow molding machine can comprise supplying hot air, for example with a temperature of 60° C. to 250° C., and/or supplying steam, for example with a temperature of 100° C. to 300° C.

Furthermore, a container comprising the fiber material, as described above or below, is provided. The container can be produced or have been produced by the method described above.

### BRIEF DESCRIPTION OF THE FIGURES

The accompanying Figures show, by way of example, aspects and/or exemplary embodiments of the disclosure for better understanding and illustration. In the figures:

FIG. 1 shows fiber structures with a trilobal form,

FIG. 2 shows fiber structures with a flat structure,

FIG. 3 shows fiber structures with a hollow structure,

FIG. 4 shows fiber structures with a rough surface,

FIG. 5 shows fiber structures with a corrugated surface, and

FIG. 6 shows a two-layer container.

### DETAILED DESCRIPTION

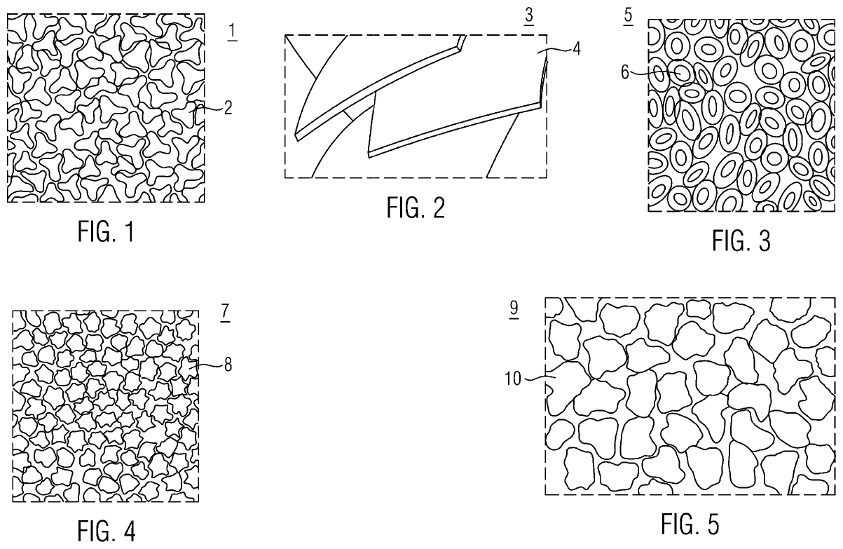

FIGS. 1 to 5 show different fiber structures which can be used in a fiber material for producing a container to ensure a predetermined stability of the produced container.

FIG. 1 shows fiber structures 1 with a trilobal form 2. The trilobal structure allows the fibers to be flexurally rigid and yield improved strength and/or stability of a container that comprises them.

FIG. 2 shows fiber structures 3 with a flat structure 4. By overlapping a plurality of such fiber structures 3, the tensile strength can be increased and accordingly, for example, and can yield improved strength and/or stability of a container comprising fiber structures 3.

FIG. 3 shows fiber structures 5 with a hollow structure 6. Due to the hollow structure 6, the fiber structures 5 and the corresponding container that comprises it can be light. Since the hollow structure 6 can have a stiffening effect, improved strength and/or stability of the container can nevertheless be brought about.

FIG. 4 shows fiber structures 7 with a rough surface 8. The rough surface 8 can cause an interlocking of the fiber structures 7 and increase the tensile strength and stability of a container comprising the fiber structures 7.

FIG. 5 shows fiber structures 9 with a corrugated surface 10. The corrugated surface 10 can lead to an interlocking of the fiber structures 9 and to an increase in the tensile strength and the stability of a container which comprises the fiber structures 9.

To produce a fiber-containing fluid mass, one type of the fiber structures or two or more different types of the fiber structures can be introduced into a fluid, such as water.

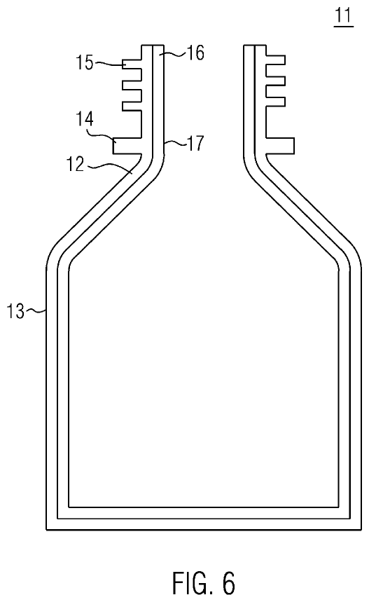

FIG. 6 shows a two-layer container 11. The container 11 comprises a first layer 12 which forms an outer surface 13 of the container and also comprises a thread 15 and a support ring 14. A second layer 16 is applied to the first layer 12 in the interior of the container 11 and forms an inner surface 17 of the container 11.

For the first layer 12, a fiber material which has been recycled or which is non-sterile or has not been sterilized can be used. The first layer 12 does not come into contact with a product added to the container 11.

The second layer 16 may comprise a fiber material that is used for the first time and/or that is sterile or has been sterilized prior to being introduced. The inner surface 17 of the container 11 can at least partially come into contact with a product added to the container 11.

For the production of the container 11, the first layer 12 of the fiber material can be introduced into a mold for forming the outer surface 13 of the container. The second layer 16 of the fiber material can be applied in the mold to the first layer 12 to form the inner surface 17 of the container 11. The fiber material of the first layer 12 and the second layer 16 may each be present as a fiber-containing, fluid mass to be introduced into the mold. After the two layers 12, 16 have been introduced into the mold, the layers 12, 16 can be pressed in the mold, and the container 11 can be produced. By pressing, at least a portion of the fluid can be pressed out of the fiber-containing fluid mass.

1. A fiber material for producing a container, wherein the fiber material comprises fiber structures for ensuring a predetermined stability of a container produced from the fiber material.

2. The fiber material according to claim 1, wherein the fiber structures comprise at least one of the following features:
viscose fibers,
a trilobal shape or a double trilobal form,
a flat structure,
a hollow structure,
a corrugated or rough outer surface,
a predetermined fiber length distribution of fibers.

3. The fiber material according to claim 1, wherein fibers of the fiber structures comprise:
lignin, banana leaves, quinine, glass fibers, metal threads and/or sutures.

4. The fiber material according to claim 1, wherein the fiber structures comprise:
a fabric structure or a mixture of different fabrics and/or celluloses and/or wood fibers.

5. The fiber material according to claim 4, wherein the fiber structures comprise viscose fibers:
fiber mixtures made of non-wood material, including cotton and/or textile fibers which comprise barrier properties, and/or crepe paper tube and/or knitted tube and/or cotton net and/or hemp.

6. The fiber material according to claim 2, wherein the fiber material comprises at least one of the following features:
the fiber material can be usable for a preform of a container to be produced therefrom,
the fiber material comprises fiber structures of natural origin, wherein one type or several different types of fiber structures are provided, wherein the fiber structures are or comprise primary fibers and/or secondary fibers,
the fiber material comprises inorganic fillers, including chalk and/or kaolin, and/or organic fillers,
the fiber material comprises biobased binders, including cellulose ethers, carboxymethyl cellulose, starch ethers, xanthan, guar, pectins, agar, gelatin and/or gum arabic,
the fiber material comprises biobased additives, including sunflower lecithin,
the fiber material comprises colorants, wherein, the colorants are biobased.

7. The fiber material according to claim 6, wherein the fiber material comprises 0% to 100% long fiber cellulose, 0% to 100% short fiber cellulose, 0% to 100% recycled paper fibers, 0% to 100% annual plant cellulose, and/or 0% to 100% cotton fibers.

8. A method for producing a container using the fiber material according to claim 1.

9. The method according to claim 8, comprising:
introducing the fiber material into a mold,
pressing the fiber material in the mold and
producing the container.

10. The method according to claim 8, comprising:
introducing a first layer of the fiber material into a mold for forming an outer surface of the container,
introducing a second layer of the fiber material, which is sterile, into the mold on the first layer for forming an inner surface of the container,
pressing the first and second layers in the mold, and
producing the container.

11. The method according to claim 10, further comprising sterilizing the fiber material for the second layer prior to being introduced.

12. The method according to claim 8, wherein the method further comprises:
producing a preform from a fiber material,
introducing the preform into a stretch blow molding machine, and
shaping the container in the stretch blow molding machine.

13. The method according to claim 12, wherein the molding of the container in the stretch blow molding machine comprises supplying hot air at a temperature of 60° C. to 250° C., and/or supplying steam at a temperature of 100° C. to 300° C.

14. A container comprising the fiber material according to claim 1.

15. The container according to claim 14, wherein the container has been produced by using the fiber material.
